(19) United States
(12) Patent Application Publication
(10) Pub. No.: US 2014/0226024 A1
(43) Pub. Date: Aug. 14, 2014

(54) CAMERA CONTROL IN PRESENCE OF LATENCY

(71) Applicant: Kutta Technologies, Inc., Phoenix, AZ (US)

(72) Inventors: Douglas V. Limbaugh, Phoenix, AZ (US); Bruce D. Elliott, Phoenix, AZ (US); Mark M. Johnson, Peoria, AZ (US)

(73) Assignee: Kutta Technologies, Inc., Phoenix, AZ (US)

(21) Appl. No.: 14/175,405

(22) Filed: Feb. 7, 2014

Related U.S. Application Data
(60) Provisional application No. 61/762,514, filed on Feb. 8, 2013.

(51) Int. Cl. H04N 5/232; H04N 7/18

(52) U.S. Cl. CPC H04N 5/23203; H04N 5/23216; H04N 7/181
USPC 348/169; 348/211.1

(57) ABSTRACT

In various implementations, systems and processes may be utilized to reduce the affect of latency in teleoperated cameras. For example, various processes may be utilized to determine latency periods and generate user interfaces based on the latency periods and/or inputs provided to the systems.

### CROSS-REFERENCE TO RELATED APPLICATION

This application claims priority to U.S. Provisional Patent Application No. 61/762,514, entitled “LATENCY IMPROVEMENT IN CAMERA CONTROL,” filed on Feb. 8, 2013, which is hereby incorporated by reference for all purposes.

### GOVERNMENT LICENSE RIGHTS

This invention was made with government support under Contract No. W911W6-12-C-0009 awarded by the United States Army. The government has certain rights in the invention.

### TECHNICAL FIELD

The present disclosure relates to latency affect improvement in teleoperated camera control, and more particularly to latency affect improvement in the remote control of Electro Optical and Infrared (EO/IR) cameras.

### BACKGROUND

EO/IR Cameras may be utilized in video camera systems for real time video surveillance, long-range surveillance, acquisitions, tracking, and laser applications. The operation of the camera may be controlled remotely. During operation of the camera, there may be a time delay or latency between when the control signal is provided for the camera and when the camera responds to the signal. Unmanned Aerial Systems (UASs), Ground Control Stations (GCSs), and the U.S. generic control stations that include a geo-rectified map and real-time video streaming application may utilize EO/IR cameras. There may be latency in controlling these cameras, such as gimbaled EO/IR cameras on moving vehicles, especially manned and unmanned air vehicles. The latency in some of these systems (e.g., GCSs and generic control station with map and video applications), have been handled by improving video encoding and decoding techniques, increasing wireless bandwidth and the rate at which data is transmitted between the Unmanned System and the GCS. However, as the Department of Defense (DoD) moves toward more net-centric warfare, multi-hop, non-line of sight (NLOS) communication networks, and publish/subscribe architectures, such as those found in Heterogeneous Autonomous Reconnaissance Teams (HARTs), these latency issues may become more pronounced.

### SUMMARY

In various implementations, Latency Improvement Algorithms (LIAs), along with Graphical User Interface (GUI) modifications, may provide users with efficient and accurate control of a gimbaled Electro-Optical/Infrared (EO/IR) camera when latency is present in the system. The LIAs and the GUI modifications may reduce cognitive workload, increase the efficiency, effectiveness and/or accuracy of controlling an EO/IR camera when latency exists in an EO/IR system.

In various implementations, one or more images from a camera may be received and one or more instructions regarding the camera may be received. A latency period may be determined. The latency period may be based on an elapsed time between a time when an instruction is received and a time when the camera performs an operation based on the received instruction. A graphical user interface may be generated based on the latency period for presentation to a user. The graphical user interface may be generated using a processor.

Implementations may include one or more of the following features. At least one of the instructions regarding the camera may include an instruction regarding an orientation of the camera. Determining the latency period may be at least partially based on a camera controller system time, time stamp, time to allow video encoding, and/or time to allow video decoding. The graphical user interface may include at least one image received from the camera and an overlay. The overlay may include one or more overlay parts presented on top of a presented image. Generating the graphical user interface based on the latency period may include displaying the latency period on the overlay. In some implementations, one or more additional instructions for the camera may be generated based on the determined latency period. Instruction(s) for the camera may be presented on the graphical user interface. In some implementations, presentation of one or more of the instructions may be restricted when the camera has allowed at least one response based on one or more of the instructions. Generating the graphical user interface based on the latency period may include presenting a virtual cross-hair based on the received instructions regarding the camera.

In various implementations, a moving object may be detected in a field of view of a camera and a determination may be made whether the moving object is maintained in the field of view of the camera. Potential position(s) of the camera may be determined based at least partially on a Kalman filter algorithm, if a determination is made that the moving object has not been maintained in the field of view of the camera.

Implementations may include one or more of the following features. A latency period may be determined. The latency period may be based on an elapsed time between a time when an instruction is received and a time when the camera performs an operation based on the received instruction. Determining a potential position of the camera may be based at least partially on the determined latency period. In some implementations, an instruction for the camera may be automatically determined based on the determined potential position to allow the camera to include the potential position in a field of view of the camera. An instruction for the camera may be determined based on the determined potential position and the determined instruction for the camera may be transmitted (e.g., to the camera). Determining one or more potential positions of the camera may be based at least partially on a determined trajectory of the moving object and/or a determined speed of the moving object. A graphical user interface may be generated using a processor for presentation to the user. The graphical user interface may include at least one image received from the camera and an overlay. The overlay may include one or more overlay parts presented on top of a presented image. At least one of the overlay parts may include a density overlay, which is based at least partially on a probability that the moving object is in an area on the presented image. In some implementations, one or more potential deviations from a trajectory of the moving object may be determined based on identified paths in an image captured by the camera.

In various implementations, an object in a field of view of a camera may be identified. A determination may be made whether the identified object is maintained in the field of view of the camera. One or more potential camera positions may be determined if a determination is made that the identified object is not maintained in the field of view of the camera.

Implementations may include one or more of the following features. Determining potential positions of the camera may be based at least partially on a determined trajectory of the moving object, a determined speed of the moving object, and/or a Kalman filter algorithm. A graphical user interface may be generated using a processor for presentation to the user. The graphical user interface may include at least one image received from the camera and an overlay. The overlay may include one or more overlay parts presented on top of a presented image. At least one of the overlay parts may include a density overlay, which is based at least partially on a probability that the moving object is in an area on the presented image. A graphical user interface may be generated using a processor and based on a determined latency period. At least one of the overlay parts in an overlay of the graphical user interface may include one or more virtual cross-hairs. The graphical user interface may include presenting virtual cross-hair(s) based on instructions received regarding the camera. In some implementations, a digital footprint of the identified object may be generated while tracking the object. A graphical user interface may be generated using a processor when a determination is made that the identified object is not maintained in the field of view of the camera. An overlay of the graphical user interface may include overlay parts, such as one or more indicia corresponding to portions of the presented image that at least approximately match the generated digital footprint. The identified object may include a moving object, in some implementations. Determining one or more potential positions of the camera may be based at least partially on a determined trajectory of the moving object and/or a determined speed of the moving object. A graphical user interface may be generated using a processor for presentation to the user. At least one of the overlay parts on an overlay of the graphical user interface may include a density overlay, wherein the density overlay is based at least partially on a probability that the moving object is in an area on a presented image. In some implementations, a latency period may be determined. The latency period may be based on an elapsed time between a time when an instruction is received and a time when the camera performs an operation based on the received instruction. Potential position(s) of the camera may be determined based at least partially on the determined latency period.

### BRIEF DESCRIPTION OF FIGURES

For a more complete understanding of this disclosure and its features, reference is now made to the following description, taken in conjunction with the accompanying drawings, in which:

FIG. 1 illustrates an implementation of an example portion of a camera system.

FIG. 2A illustrates example predicted LIA inputs and outputs for an implementation of the system.

FIG. 2B illustrates example command backlog LIA inputs and outputs for an implementation of the system.

FIG. 3 illustrates an implementation of an example video window control overlay.

FIG. 4 illustrates an implementation of an example rate based slew overlay.

FIG. 5A illustrates probabilities of a sub region containing a target in an implementation of an example 2×2 sub-region search.

FIG. 5B illustrates asymmetric Traveling Salesman Problem (TSP) with virtual costs in an implementation of an example 2×2 sub-region search.

FIG. 6A illustrates an implementation of an example video zooming in LIA interface.

FIG. 6B illustrates an implementation of an example video zooming out LIA interface.

Like references in the various drawings indicate like elements.

### DETAILED DESCRIPTION

In various implementations, a system may be utilized to improve camera usage. For example, graphical user interfaces may be generated by a processor of the system to present information to a user related to a camera latency period (e.g., the elapsed time between when an instruction is received and when a camera responds to the instruction), tracking of objects, potential deviations from an expected trajectory of an object and/or other appropriate information. The system may, in some implementations, automatically generate instructions to alter and/or maintain a camera position based on information received and/or determined and transmit the instructions to the camera. The camera may respond to the instructions received.

In various implementations, a Latency Improvement Algorithm (LIA) may be utilized to improve latency issues in cameras.

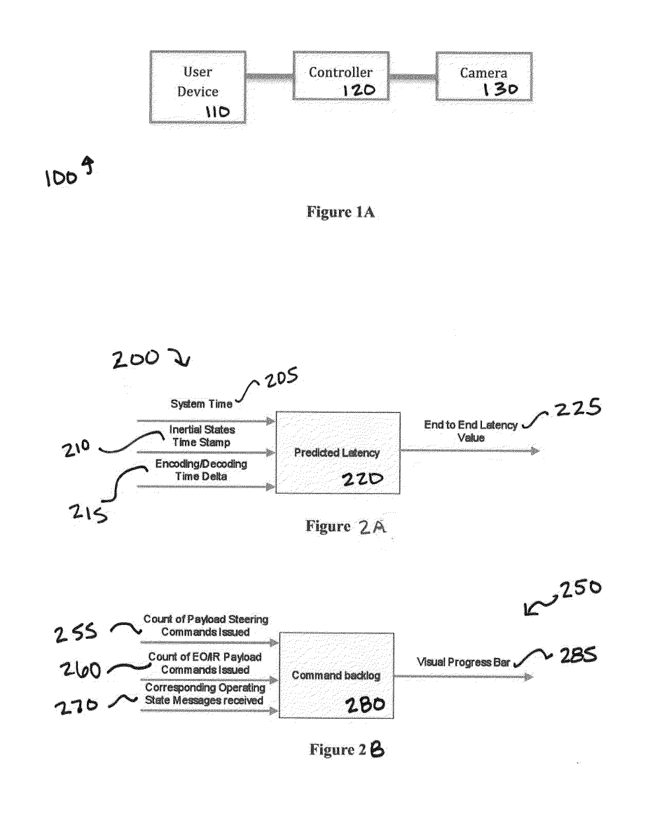

As illustrated in FIG. 1, a camera system 100 may include a camera 110, such as an EO/IR camera, a controller 120, and a user device 130. Any appropriate camera 110, controller 120, and/or user device 130 may be utilized. For example, the user device 130 may include a computer, such as a tablet or laptop computer.

The camera 110 may capture one or more images and provide the image(s) through a graphical user interface (GUI) on a presentation device (e.g., monitor and/or screen) of the user device 130 (e.g., personal computer, laptop computer, and/or tablet computer).

The controller 120 may manage operations of the camera 110. For example, the controller 120 may receive instructions from a user (e.g., via a user device) regarding the camera 110 and/or transmit instructions to the camera. The controller 120 may be incorporated into the user device 130 and/or the camera 110. In some implementations, the camera 110, controller 120, and/or user device 130 may be integrated.

The user device 130 may be in communication with the camera 110 and provide instructions (e.g., Field of View (FOV), position such as gimbal orientation, shutter speed, and/or exposure) for the camera. The user device 130 may present a graphical user interface generated by a processor (e.g., of the user device and/or the controller). The graphical user interface may include one or more of the images captured by the camera and/or one or more overlays. The images captured by the camera may be displayed through the graphical user interface as received and/or which received image is presented through the graphical user interface may be based on instructions received from the user device and/or the controller. The overlay may include one or more overlay parts. The overlay may be displayed in the graphical user interface such that overlay parts are presented on the image(s) captured by the camera. For example, portions of the image may be hidden by the overlay part that is presented in the overlay. The overlay parts may include symbols, shapes, text, and/or other appropriate overlay parts. For example, the overlay parts may include cross-hairs and/or indicia, such as highlighting, flagging, etc.

In some implementations, there may be a latency period between when the user provides the instruction through the user device and when the camera follows the instruction. The latency period may inhibit user functionality since the camera may be slow to zoom, slow to track, etc. The latency period may also increase cognitive workload for the camera operator by causing confusion as to whether a command has been processed or not. In various implementations, the described systems and methods may provide features that reduce the impact of the latency period.

The Latency Improvement Algorithm (LIA) may utilize Standardized Agreement (STANAG) 4586 (e.g., as described in STANAG 4586—“Standard Interfaces of Unmanned Aerial Vehicle (UAV) Control System (UCS) for NATO UAV Interoperability”, Edition 2, Amendment 1, 28 Aug. 2009) messaging and the Video Window to provide multiple aids to assist the user in operating the camera and tracking targets during controller latency. These aids may work in conjunction with the Camera slewing, Camera zooming, target recognition, moving object indication, and target selection.

In various implementations, a camera may capture one or more images. The images may be received (e.g., by the controller and/or user device). For example, the camera may send a continuous stream and/or intermittent stream of images for presentation on a user device (e.g., via a graphical user interface). Instructions for the camera may be provided by a user (e.g., through the user device) and transmitted to the camera (e.g., by the user device and/or the controller). The instructions may be received (e.g., via the graphical user interface and/or by the controller). A processor of the system (e.g., the controller and/or the user device) may determine a latency period. The latency period may be based on the elapsed time between the time when at least one of the instructions is received and the time when the camera performs an operation based on the received instruction. The determined latency period may be stored in a memory (e.g., of the controller, the camera, and/or the user device). In some implementations, a latency period may be determined for a camera and then stored in the memory of the camera, controller, and/or user device. Then, when the latency period is to be later utilized (e.g., by a processor of the controller and/or the user device), a processor may retrieve the stored latency period to determine the latency period. A processor of the system (e.g., using information stored in a memory of the system and/or information received and/or stored in the memory) may then generate one or more graphical user interfaces based on the latency period. For example, the latency period may be presented to a user via a graphical user interface generated by a processor (e.g., of the user device). The latency period may be presented to the user via an overlay (e.g., latency period value shown on an overlay and/or predicted cross-hair position may be shown on an overlay).

Latency Prediction Value and Display—In various implementations, latency prediction may provide an end to end value for the current amount of time for Camera commands and continuously sent status messages to travel between the Air Vehicle (AV) and the Camera Controller. The display of this Latency value allows the user to anticipate the lag in Camera control and anticipate the response of user input. The latency value is also utilized in other processes to trigger specific actions and aids.

Latency prediction may utilize, but is not limited to utilizing, the following inputs for calculation, which are illustrated as process 200 in FIG. 2A:
Camera Controller system time;
Time stamp from currently received STANAG 4586 Message #101 (Inertial States); and/or
Additional time delta to account for video encoding and decoding.

As illustrated, an End to End latency value 225 may be generated using an algorithm to predict latency period 220 based at least partially on system time 205 (e.g., camera controller system time); inertial states time stamp(s) 210, such as one or more time stamps from a currently received message (e.g., STANAG 4586 Message #101); and/or encoding and/or decoding time 215.

Command Backlog Display LIA—In some implementations, displaying the backlog of commands to the user may provide another way for the user to know when the Camera has finished executing the sequence of user inputs. For example, when an instruction (e.g., a command) for a camera is received, an overlay part, such as the instruction(s) or a representation(s) of the instruction(s) (e.g., symbol, abbreviation, and/or other appropriate representation) may be presented on a graphical user interface generated (e.g., by a processor) for presentation on a user device (e.g., via an overlay). In some implementations, instructions to which a camera has responded (e.g., performed an operation based on the received instruction) may be restricted from presentation on the graphical user interface. For example, a visual progress bar fills up as commands are issued and begins to clear out as acknowledgment receipts are received by the AV. In this manner, the user can discern when all issued commands have been executed. This progress bar may be displayed on the Camera Controller, the Map Window, and/or the Video Window.

The Backlog Command Display may utilize, but is not limited to utilizing, the following inputs for calculation, illustrated in process 250 of FIG. 2B:
Count of issued STANAG 4586 Message #200 (Camera Steering Command) and Message #201 (EO/IR/Laser Camera Command) from the Camera Controller to the Camera; and/or
Count of corresponding operating state STANAG 4586 messages from the Camera Controller to the Camera.

As illustrated, a visual progress bar 285 may be generated (e.g., by a processor of the controller and/or user device) using a command backlog algorithm 280 which is based at least partially on a count of payload steering commands issued 255, a count of EO/IR payload commands issued 260, and/or corresponding operating state messages received 270. One or more graphical user interfaces may be generated (e.g., by a processor of the system) based on the results of the command backlog algorithm, such as a visual progress bar, a listing of instructions to the camera issued, etc. The command backlog algorithm may be executed manually (e.g., by a request of the user) and/or automatically.

Instantaneous Virtual Cross-Hair Slew LIA—In some implementations, instantaneous movement of a virtual cross-hair (e.g., an overlay part on an overlay of a generated graphical user interface) on the Video Window while commanding Camera slew on the Camera Controller during latency may provide the user with comfortable control of the Camera and may reduce Camera under steering and over steering. Thus, the user may no longer need to guess where the real cross-hair may end up when the Camera concludes its slewing movements.

For the LIA to provide instantaneous virtual cross-hair movement in the Video Window that correlates to the issued slewing movements, the system may utilize, but is not limited to utilizing, the following inputs in calculation:

When slewing the Camera from the GCS
Direction of the Slew Commands;
Magnitude of the Slew Commands;
Interval Time of Slew Commands; and/or
Current location of the virtual cross-hair on the Video Window.

If data communication latency between the controller and the air vehicle is greater than a predetermined latency period (e.g., approximately 1 second or greater), the LIA may provide the Video Window with a virtual cross-hair that gives the user immediate information as to where the center Field of View may move to when the latent commands are executed by the Camera. The predetermined latency period may be stored in a memory of the system and retrieved by a processor of the system (e.g., the controller and/or user device of the system).

The Video Window may immediately move the virtual cross-hair in the direction and magnitude issued by the user (e.g., through an instruction) via the Camera Controller during latency.

The Video Window may continually update the virtual cross-hair position while directional commands are given by the user via the Camera Controller during latency.

The Video Window may stop updating the virtual cross-hair position when directional commands are no longer given by the user via the Controller during latency.

The Video Window may remove the virtual cross-hair when the center Field of View has been updated to the virtual cross-hair location, or to within some nominal distance of the virtual cross-hair location.

The Video Window may save data parameters needed to determine video footprint at the start of Camera commanded slewing during latency.

The Video Window may use the sensor center stare point latitude, longitude and altitude in the saved data to base the starting position of the virtual cross-hair.

At the start of slewing, the sensor center stare point latitude, longitude and altitude in the saved data may correspond to the center pixel location in the displayed video.

The Video Window may use the sensor center stare point latitude, longitude and altitude in the saved data and the commanded Camera slew to compute updated latitude, longitude and altitude sensor center prediction stare point locations for the virtual cross-hair.

The Video Window may use the sensor center prediction stare point latitude, longitude and altitude to back project the position of the virtual cross-hair to a pixel location in the video window.

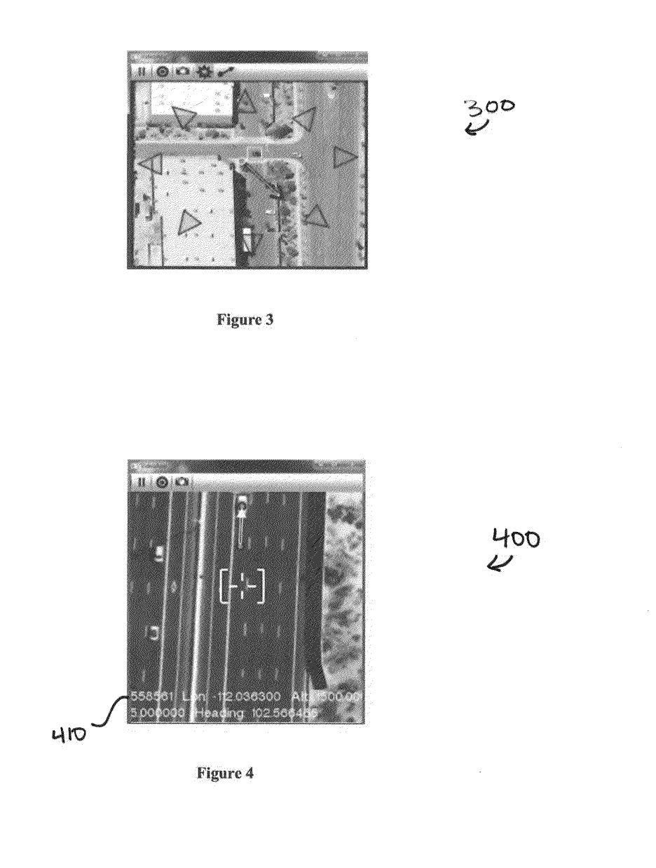

Camera Control Overlays on Video Display Window LIA—In some implementations, Video Window GUI (e.g. virtual joystick) overlays used for slewing an EO/IR Camera may be integrated into the Video Window, as illustrated in the example graphical user interface 300 in FIG. 3. The Camera Control Overlays allow the Camera Operator to maintain focus on the Video Window during camera control instead of sharing focus between the Video Window and other GUI and non-GUI elements during camera control. The Video Window Overlays create the appropriate STANAG 4586 Message #200 (Camera Steering Command) message sequence and sends the formatted messages to the Camera.

To slew the Camera directly from the Video Window, the following inputs may be utilized by the Video Window:
Cardinal direction of the click-and-drag movement on the Video Window;
Magnitude of the click-and-drag movement on the Video Window; and/or
Interval Time of the click-and-drag movement on the Video Window.

The ability to define a slew rate and direction may be incorporated within the Video Window Camera Control Overlays, illustrated in FIG. 4. This LIA may issue constant Camera Steering Commands (STANAG 4586 Message #200) with populated horizontal and vertical slew rates to the Camera using the slewing inputs made on the Video Window. The Video Window may display a visual cue 410 of the issued direction and magnitude of the constant slew.

To calculate the constant slewing, the Rate Based Slewing LIA may utilize, but is not limited to utilizing, the following from the inputs made on the Video Window:
Time of the 1st issued click;
Location of the 1st issued click;
Time difference between the 2nd issued click and the 1^{st}; and/or
Magnitude of the distance between the 2nd issued click and the 1st.

The Video Window Camera Control Overlay may allow the user to define a slew rate and direction.

The Video Window Camera Control Overlay may allow the user to switch between inertial slewing and rate slewing.

The Video Window Camera Control Overlay may display to the user a visual indication as to the commanded direction and magnitude for assisting the user in “leading the target”.

While rate based slewing is engaged, the Video Window Camera Control Overlay may allow the user to make adjustments to the direction and rate that the Camera is slewing.

The Video Window Camera Control Overlay may allow the user to immediately stop the Camera from slewing at a constant rate.

In various implementations, the system may detect and/or identify objects, such as moving objects and/or nonmoving objects. The system (e.g., controller and/or user device) may receive image(s) captured by the camera. Objects may be identified based on user input (e.g., a user may select an object to identify and/or track) and/or automatically by the system (e.g., the controller may automatically detect an object based on object criteria such as a digital footprint, motion, and/or other information). The camera may track moving objects, in some implementations. For example, the position of the camera may be adjusted and/or maintained automatically to keep the moving object in the field of view of the camera. In some implementations, a determination may be made that the identified object (e.g., moving object and/or approximately stationary object) is not in the field of view of the camera. A notification may be transmitted to the user (e.g., via an overlay part, such as a notification message, on a generated graphical user interface). A potential position for the camera may be determined (e.g., by a processor of the controller and/or user device) if the determination is made that the identified object is not in the field of view of the camera. The potential position may be determined such that the probability that the identified object is in the field of view of the camera is raised (e.g., when compared with the position of the camera in which the field of view was determined not to include the identified object). One or more instructions (e.g., automatically by the controller or manually via the generated graphical user interface) may be generated and transmitted to the camera to adjust and/or maintain the position of the camera at least partially based on the determined potential position.

In some implementations, one or more LIAs may be utilized with the system. For example, a latency period may be determined and a potential position of the camera may be based at least partially on the determined latency period. In some implementations an overlay may be generated based at least partially on the determined latency period. By presenting the latency period to the user, overslewing and/or other overcorrection may be inhibited when searching for the identified object.

In some implementations, determining potential positions of the camera may be based on, for example but not limited to previous position, a determined trajectory of a moving object and/or a determined speed of the moving object. Graphical user interface(s) may be generated using a processor for presentation to the user that include a density overlay. The density overlay may be based at least partially on a probability that the moving object is in an area on a presented image.

In some implementations, one or more potential deviations from a trajectory of an identified object, such as a moving object, may be determined based on identified paths in an image captured by the camera. For example, in an image captured by the camera that includes roads or trails, exits and path alternatives may be identified. One or more of the identified exits and/or path alternatives may be presented on the graphical user interface using indicia, such as highlighting, arrows, etc.

In some implementations, a digital footprint of the identified object may be generated (e.g., by the system) while tracking the object. The digital footprint may be saved in a memory of the system (e.g., directly or indirectly coupled to the system). A graphical user interface may be generated for presentation to the user that includes information related to the digital footprint. For example, when an identified object is determined to not be in a field of view of a camera, the system (e.g., a processor of the system) may identify portions of the image presented to the user that are similar (e.g., have similar properties) to the digital footprint of the identified object. A determination may then be made whether one or more of the identified portions include the identified object, which was out of view (e.g., determined to not be in a field of view of the camera). In some implementations, an overlay of the graphical user interface may include one or more indicia corresponding to portions of the presented image that at least approximately match the generated digital footprint.

Moving Target Indicator LIA—In some implementations, the ability to auto detect and indicate moving objects in the Video Window's Field of View (FOV) may be incorporated into the Video Window (e.g., graphical user interface generated based on instructions stored in a memory of the system and executed by a processor of the system). This Moving Target Indicator (MTI) software (e.g., instructions stored on a memory of the system) detects objects that are independently moving on the Video Window with respect to the background image.

The MTI software LIA displays bounding boxes (e.g., overlay parts in the overlay of the graphical user interface generated) around moving objects that have been located within the FOV, displays the object's estimated heading and speed, and/or numbers the objects.

For the MTI software LIA to indicate, display heading and speed, and number moving objects in the video FOV, the following inputs may be utilized, but the system is not limited to utilizing:
X-coordinate of the object in the video frame;
Y-coordinate of the object in the video frame;
A retained count of the number of detected objects currently in the FOV; and/or
Heading and speed calculations from a Kalman filter.

The Video Window may overlay a bounding box on moving objects that the MTI LIA has detected and defined, up to a total of 5 objects, in some implementations.

The Video Window may overlay unique identifications (e.g., overlay portions) sent from the MTI LIA for moving objects in the FOV to assist the user in distinguishing the moving objects. The unique identifications may include text, symbols, colors, and/or other appropriate identifiers.

In some implementations, the unique identification/number given to moving objects may allow the user to more easily select a specific moving object from the FOV using that object's number when multiple moving objects are present. It also allows the user to associate a specific target in the FOV with its location indicated on the map.

The Video Window may allow the user to select an indicated moving object within the FOV to view the object's speed and heading.

The Video Window may allow the user to select an indicated moving object within the FOV to command the Camera to auto-track the selected object.

The Video Window may allow the user to display moving object indications on the video.

The Video Window may allow the user to disable the display of bounding box and identification overlays.

Target Tracking Auto-Lock LIA—In some implementations, a single target may be tracked among multiple moving targets in the FOV by using an Auto-lock Tracking LIA. Camera slewing commands may be issued based on the predicted location, speed, heading, and/or latency in the video data. Location, speed and/or heading values may be a result of calculations done by the MTI software, in some implementations. These slewing commands may be issued automatically for the target selected from the numerical drop-down GUI window. In this manner, the LIA works to keep the image footprint centered on the predicted target position. If latency gets large enough, a user may manually initiate a zoom out command to the Camera to ensure the target remains within the FOV.

Target Digital Fingerprint LIA—In some implementations, the Digital Fingerprinting LIA is incorporated to identify, extract and then compress characteristic components of a video. The Digital Fingerprinting LIA may effectively identify and compare digital video data. This analysis of the video data is based on any number of visual video features including, but not limited to, key frame analysis, color, and/or motion changes during a video sequence. Clusters of those features that uniquely identify a target may be created to robustly match a target from one image to the next.

The LIA Digital Fingerprint may use image template matching techniques to create the digital fingerprint data for target recognition. These techniques may include, but are not limited to:
Key feature detection;
Histograms of Oriented Gradients (HOG);
Scale-space representations such as Image Pyramids;
Image color plane separation; and/or
Machine learning techniques such as Support Vector Machine (SVM) discriminators.

The LIA Digital Fingerprint may use techniques and strategies that can discriminate targets based on, for example:
Object color information;
Object size relative to size of other local image objects; and/or
Object velocity relative to background image.

The LIA Digital Fingerprint may use techniques and strategies that are robust and invariant to, for example:
Local and global image illumination changes;
Target orientation changes;
Global image scale changes; and/or
Occlusions due to foreground objects or partial off-screen targets.

Matching Target Recognition LIA—In some implementations, the Matching Target Recognition LIA may highlight one or more objects in future video frames that were a match to characteristics of similar objects in the digital finger print database. This LIA may activate once track on an object was inadvertently lost (e.g., a determination is made that the identified object is not in the field of view). Similar objects continue to be highlighted in the FOV until the user indicates the highlighted target to track, in some implementations.

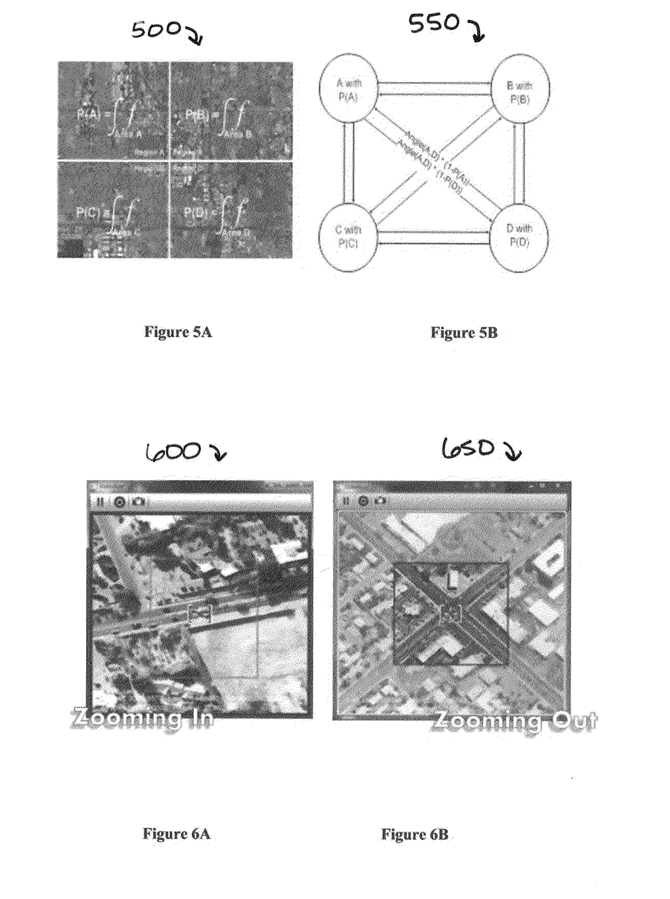

Auto Slew to Predicted Target Locations LIA—In some implementations, the Auto Slew to Predicted Target Locations LIA initiates an efficient Camera auto slew to (i) bring the target back to the FOV (faster slew using the target search process presented below) and then to (ii) slew to the predicted target using an iterative manner (stabilized slower slew). This process may include one or more of the following steps, portions of which are illustrated in the example graphical user interface 500 illustrated in FIG. 5A and the example schematic 550 illustrated in FIG. 5B:
1. Adjust camera position. For example, the Camera may be zoomed in and/or out to optimize the FOV based at least partially on the target type (e.g., a person, a car, etc. used in generic control station route nominations). Adjusting the camera position may allow the digital finger print comparison to be accomplished with the minimum number of pixels in the image;
2. An area of the bounded region containing the target may be estimated (e.g., by a processor of the system). The area of the bounded region may be divided into M*N sub-regions, such that each of the sub-regions may be fully covered by the Camera using the FOV given in step 1, as illustrated in FIG. 5A;
3. The cumulative probability may be determined for each sub-region, as illustrated in FIG. 5B. For example, the Probability Distribution Function (PDF) f, may be utilized to determine the cumulative probability. The virtual costs may be applied from one sub-region to another;
4. The sub-regions may be searched using the solver to the asymmetric Traveling Salesman Problem (TSP) with the virtual costs; and/or
5. If the digital fingerprint comparison matches, the found potential target may be stored (e.g., in a memory of the system). This information may be provided to the user for further instruction. If the user accepts the current result, the search may break with success and stay on the target. If the search is complete it may stop with the findings. Otherwise, the search may continue until it exhausts its search space or the user stops the search.

In some implementations, the LIA may find the target with minimum virtual costs. For example, the system may try to find the target by minimizing the Camera slew commands. The process may start the search at the current sub-region the Camera is pointing at where the virtual cost is zero.

Virtual Zooming LIA—In some implementations, the Virtual Zooming LIA may incorporate an instantaneous zooming box and/or image reduction onto the Video Window to assist the user with zooming in and zooming out the EO/IR sensor Camera. The example graphical user interface 600 illustrated in FIG. 6A and the example graphical user interface 650 illustrated in FIG. 6B illustrate the use of the zooming in and zooming out LIAs respectively. During latency, the zoom-in LIA displays a box that corresponds to the zoom level commanded by the user to the Camera. The zoom-in box displays to the user the approximated zoom level being commanded. When the Camera completes the zoom-in, the Video Window will be displaying video at that new zoom level and the box is removed from the Video Window. The zoom-out LIA displays a shrunken video image scaled to mimic the zoom-out command issued by the user during latency. The shrunken video image in the Video Window is then stitched together with shaded satellite imagery of that location until the updated video from the Camera reaches the Video Window, replacing it with actual video.

Multiple Mode Target Selection LIA—In some implementations, a Multiple Mode Target Selection LIA may allow the operator to select a moving target to be tracked utilizing one or more of the following selection methods:
Processes (e.g., one or more of the various LIAs) used for selecting ground reference Stare-At points in the Video Window (e.g., processes used by a generic control station that includes a geo-rectified map and real-time video streaming applications) may be leveraged for commanding the Camera, to allow the user to command the Camera to track a moving target. The user may be able to place the cursor directly in the Video Window to select the moving target seen in the field of view (FOV). When the organic EO/IR sensor Camera pops off of the target, the described automating tracking may engage and track the desired target.
In some implementations, processes used for selecting Latitude and Longitude Stare-At points in the Map Window (e.g., used by a generic control station that includes a geo-rectified map and real-time video streaming applications) may be leveraged for commanding the Camera, to allow the user to command the Camera to track a moving target. The Map Window may display the possible location of the target generated from calculations performed via MTI software. The user may have the ability to select the displayed moving target by using a cursor directly on the Map Window and the Camera may receive the command to follow that target. This ability gives the user control to select a target even if it currently is not in the Camera's FOV.
In some implementations, processes may include a feature of selecting a moving target by use of a numerical drop down selection menu or bar. The described systems and processes may integrate the drop-down box with the MTI software to coordinate the numbering of moving targets based on the most probable moving target location and the digital fingerprint database as discussed previously in this document. The user may be able to select the numbered target that he/she wishes to track. The Camera may then track that target and keep it in the video FOV using the automated tracking LIA. Numerically numbering the moving targets is an essential design that may allow the use of Auto Cycling and Voice Control, which may leverage this feature and are discussed below.
The Auto Cycling feature commands the Camera to auto cycle through the moving targets that have been detected and numbered. Auto cycling may begin with the moving target that is most probable to matching the target when auto tracking was lost and continue to loop cycle targets with the EO/IR sensor Camera until stopped by the user.
The Voice Control feature adds the ability to select a moving target on the Video Window or Map Window by use of voice recognition commands. A real voice recognition application may be designed and implemented in a way that allows the user to interact with the Camera controller in a hands-free technique for selecting a specific moving target.

Video Mosaic LIA—In some implementations, the Video Mosaic and Stitching LIA may orthorectify Unmanned Aeronautical Vehicle (UAV) video and produce a merged 2D projection. This may provide the user with the ability to command a desired route- or area-of-interest and have an up-to-date, large-scale 2D map be generated on-the-fly. In addition, the LIA may stitch together the mosaicked 2D image with satellite images to help the user predict where a moving object might be headed when regions with very little information are available. An efficient real-time mosaic may be particular beneficial when satellite images are stitched together with the mosaic to help the user predict where a moving object might be headed. Near real-time speed is attained by taking advantage of available GPS and other UAV telemetry data when computing homographies between images and pushing the computation to a graphics processing unit (GPU). In addition, the accuracy may be improved by using an existing worldwide elevation database, strongly bounding one of the larger error sources.

Voice Recognition Commands LIA—The Voice Recognition Commands LIA may allow the user to select a target to track with his voice (e.g. Track target two) and engage specific Camera control commands (e.g. inertial slew, rate slew modes, take-photo). The LIA also may integrate a set of text to speech commands to keep the user informed of what actions the LIA system is performing (e.g. Roger, tracking target two). With this LIA feature, the user may stay focused on the “task at hand” and/or may reduce the tedious process of interaction with the Video Window, which may introduce more latency in an already latent system.

In some implementations, the efficiency and effectiveness of tracking moving targets may be increased when latency is high. To accomplish moving target tracking more gracefully, an air vehicle may need to work constructively with the LIAs. That is, the LIAs need to be able to task the air vehicle and put it in a better position to follow a moving object on the ground (i.e. sensor guided flight mode). For example, in an auto-routing using a generic control station with geo-rectified mapping and real-time video streaming applications, this may require updating such a system to initiate turns more rapidly than it currently does. That is, the UAS routing protocol was based upon the generic assumptions that were made for creating safe multi-waypoint routes within the Safe Airspace Volume (SAV). For this effort the auto-pilot simulator may be updated to allow it to immediately undertake a heading change that turns the vehicle in the direction of a moving target and transitions the AV to a safe loiter point ahead of the target—within the confines of the SAV. This approach may be adopted, in some implementations, because some commercial auto-pilots can take a heading command as opposed to a multi-waypoint route, and therefore our LIA can produce a more generic solution in the event that it is integrated onto other platforms that are not UAS auto-routing compliant.

### Example 1

During use, an operator may be unaware of the amount of latency in the system and thereby frequently overshoot a target. The latency in a system is highly dependent on the number of wireless hops a command jumps through to reach the end state.

In various implementations, the described systems and processes may be utilized to display the latency to the operator and thus may reduce the likelihood that the target is overshot. For example, since Army UASs conform to STANAG 4586 telemetry standards as dictated by the DoD Interoperability Working Group, the described system may exploit the timestamp data in the common STANAG 4586 messages to estimate system latency. That is, to estimate the end to end Camera command latency (GCS to UAV Camera hardware) in the system, LIA exploits the time stamp data in STANAG 4586 messages 200, 201 and 302. The time it takes from when a Camera command (slew for instance) is sent in STANAG 4586 messages #200 (Camera Steering Command) and STANAG 4586 messages #201 (EO/IR/Laser Camera Command) until the “activated” Camera status is received in STANAG 4586 message #302 (EO/IR/Laser Operating State), may be utilized to estimate the total system latency. An additional time delta is then added to the control system latency to account for delay that comes from video encoding and decoding. Once the latency is estimated, the approximated value of the end to end latency is provided to the operator. If the operator sees a quantitative value of the latency, the operator would be less likely to over steer the Camera and take appropriate control actions when slewing the Camera (i.e. gently nudge the Camera). Furthermore, the value for the estimated latency is utilized to trigger the implementation of specific LIA and GUI features.

### Example 2

During use, a camera's auto-tracking feature may stop tracking a moving target. Many unmanned systems' Cameras contain an embedded tracking system that can lock onto fixed or moving targets. In the case of the moving targets, the Camera may continue to track an object if the object exhibits enough contrast between the target object and its background imagery. However, it is predicted that in the event that the object/vehicle traverses under a viaduct, or terrain or clouds obstruct the Camera's view even for a brief period of time, the Camera tracking feature can quit tracking or “pop-off” of the target. Typically, in the event that the Camera loses its track, it may coast for a period of time in the direction of the tracked object and try to re-engage the tracker. When the target track cannot be re-established, a difficult scenario arises for the operator. The operator may manually slew the Camera to get the desired image in the center FOV to re-gain track. This may be a very difficult task if there is a lot of latency in the control system. Furthermore, the desired object might be outside the current FOV and the operator loses situational awareness associated with the location of the object.

In various implementations, the described systems and processes may assist the operator. A Kalman filter algorithm may begin computing the target's latitude and longitude, the object's speed, as well as the computed latency within the system. When the system indicates via STANAG 4586 messages that the track has been lost, the LIA may perform one or more of the following:
a. Target Probable Location Density Overlay: Based on the computed trajectory, speed, and video latency from where the target track was lost and how far the vehicle would have traveled, the operator would be provided with a density overlay on the map application that indicates the probability of where the object is estimated to be within a given amount of time. It may overlay a moving target on the map display. The application may also indicate on the video display the direction and magnitude that an operator should slew the Camera to regain the target.
b. Target Path Prediction: In addition to the feature above, the application may determine if the vehicle is heading along a roadway by inspecting vector graphs within the imagery database. If the LIA determines the moving target is traveling along a roadway, the LIA may look ahead to determine if there are any upcoming exits or turns the vehicle can take. If exits exist, the LIA may place separate and distinct moving icons (based on the computed speed of the object) in the directions of the upcoming exits on the map display and provide a warning to the operator that the vehicle may veer from its current trajectory.
c. Auto Zoom-Out: In parallel to the above actions and based on the latency as well as the estimated trajectory, the LIA may send a Camera slew and an auto-zoom out command so that the estimated highest-probability target location may appear in the center of the FOV. Also, the LIA may resend the auto-track engage command with the same sequence of messages to assist in locking onto the target once the Camera has slewed to the commanded location.
d. Digital Fingerprint Highlighting: Furthermore, Intel Open Computer Vision (OpenCV) functions may be utilized to create an image database of the object while it is being tracked and may, in essence, create a digital fingerprint of the object. When track is lost, the Intel OpenCV libraries and the object's digital fingerprint may be utilized to highlight images in the FOV that match the digital fingerprint of the object. It is envisioned that this may reduce the cognitive workload of the operator and allow the operator to find the target more quickly in the video frame. Objects that match the digital fingerprint may be highlighted in the video frame as well as on the map display and the operator can select the correct object. Once selected, the system may utilize data from the Kalman filter (rate, direction, and highest probability of location) to compute an auto-slew just ahead of the target, auto zoom-in, and trigger the organic target tracking of the Camera. This is a similar feature to the current track search command of the generic control station that includes a geo-rectified map and real-time video streaming application. However, the digital fingerprint is a new addition to this same concept. If the location is a false-positive, the application may allow the operator to slew to the other estimated locations quickly and cycle through the locations with a simple click of the button while it keeps updating the estimated target locations in the background.
e. Target Search: A scenario is envisioned in which an object is outside the current FOV, and the Kalman filter determines the most probable location of it. The operator could then initiate a “find lost target” command and the Camera would be commanded to slew the camera over the area of highest probability quickly. During the Camera area search, the LIAs highlight objects (by drawing a box around them) if they match the digital fingerprint. The operator is allowed to select an object to confirm a match or select a button to have the LIAs keep searching.

### Example 3

An operator may have difficulty locking onto a fast moving target. For example, an operator may see a moving target of interest in the video and wants to follow it, but due to latency in the system and operator reaction time, the object travels outside the FOV and is lost.

In various implementations, the described system and processes may be utilized to assist the operator. For example, one or more of the following operations may be performed by the described systems and processes:
a. Speed and Direction Estimated Auto Slew: The operator can enter the system into a vector-based slew rate mode. The LIA in this solution may estimate the speed and direction of moving objects in the video frame and draw a box around the moving objects. The operator is then allowed to select a particular boxed-object for computing a directional slew-rate command. The LIA may take into account the latency of the system, the AV speed, the AV heading, and the object's estimated speed and heading, to compute a set of sequential and appropriate slew rate commands and direction. The first set of Camera commands may take into account the latency to get the Camera caught up with the moving object and the next set of commands may be to set the Camera to coast at a constant speed and direction until commanded to stop by the operator. When the system is commanded to stop, the LIA may calculate the future location of the object in the FOV, account for the latency in the Camera control and send an auto-slew command to the Camera to center the target in the FOV.
b. Slew Rate Override: In some implementations, the operator may “override” the algorithm by indicating the direction and magnitude of slew rate. As the operator drags the arrow along the video window, the GUI displays an approximate slew rate vector for the Camera to catch up to the object. These types of commands may also assist the LIA in computing a multi-waypoint flight plan to steer the AV in the direction of the moving target.

### Example 4

An operator may lose a target and may not be sure where to find it, during use of a camera system. An operator can easily lose track of even a static object in a video feed if the latency is extreme, which in turn amplifies the effects of over steering and increases cognitive workload. A frustrated operator becomes disoriented and creates a cyclical anxiety-driven increase in workload when looking at a soda-straw view of the world and trying to find an object that was once inside the Camera's FOV. For instance, the operator loses track of an object which in turn frustrates the operator. There is a lot of latency in the control system which causes the operator to over steer the Camera additionally frustrating the operator even more. Anxiety increases. The operator starts searching more frantically for the object and decisions are made more emotionally out of frustration than logic. The LIAs are designed to reduce the cyclic-driven anxiety and keep the operator thinking logically.

In various implementations, the described systems and processes may be utilized to improve user experiences and/or thus increase the likelihood that the operator can recover a target. For example, one or more of the following operations may be utilized:
a. Instantaneous Virtual Cross-hair Slew: Allow the operator to put the Camera controller (e.g. EO/IR gimbaled sensor Camera controller, joystick, touchpad, etc.) in a mode that allows a virtual cross-hair to be instantaneously moved on the Video Window and Map Window. This allows the operator to locate the virtual cross-hairs on an object or spot on the map on which the operator wants to focus and provides an almost instantaneous feedback to where the operator wants to point the Camera. While the crosshairs are located on the desired object or on the desired location on the map, the LIA engages to compute the coordinates of the object and send the appropriate slew and lat/long slave command to the Camera. The current “track while search” feature of the generic control station that includes a real-time video streaming application uses a secondary set of crosshairs to command the Camera. However, the “track while search” feature is dependent on getting appropriate commands to the AV's Camera and is subjected to the latency within the system. This new feature allows the operator to slew the cross-hairs on the Video Window as well as the Map Window instantaneously. In some implementations, the instantaneous feedback provided to the operator may provide the operator with better feedback and/or reduce anxiety levels when controlling the Camera—especially in high-latency systems.

### Example 5

An operator zooms in/out too much and loses the target. An operator commonly “over zooms” the EO/IR camera during latency. Operators tend to compensate for this by zooming very slowly so as not to zoom in too far and or zoom out too much.

In various implementations, the described systems and processes may reduce this tendency. Similar to providing a moving cross-hair described in the Instantaneous Cross Slew Hairs described above, the described systems and processes may compute an instantaneous zoom box within the FOV to indicate to an operator how much zoom command is being input. Once the box gets to the appropriate size, the operator can quit zooming and wait for the actual Camera to catch up. For zooming out, the described systems and processes may reduce the current image scale to mimic the commanded zoom-out level and stitch corresponding satellite imagery around the boarder where real-time imagery is not available. These tools may provide the operator the ability to better approximate what the Camera may do and reduce the iterations that an operator may need to go through to get to the desired zoom level.

### End of Examples

Various processes have been described, which may be implemented by various systems, such the system described in FIG. 1. Various operations in the processes may be added, deleted, and/or modified. In some implementations, a process may be performed in combination with other processes and/or systems. Instructions for one or more of the operations of a process may be stored in a memory of the system (e.g., memory of the camera, controller, and/or user device). The instructions may be retrieved from the memory and executed by a processor of the system (e.g., processor of the camera, controller, and/or user device).

A field of view may be an area or location of which an image is captured by a camera. For example, a field of view of a camera may be the images captured and displayed on a presentation device (e.g., screen or monitor) of a user device.

In various implementations, the user device, controller, and camera may be coupled directly and/or indirectly (e.g., WiFi and/or Bluetooth).

Although users have been described as a human, a user may be a person, a group of people, a person or persons interacting with one or more computers, and/or a computer system.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

In although devices and controllers have been specifically described with reference to specific implementations, other devices and/or controllers may be utilized as appropriate. For example, the controller may be a programmable logic device or other computer coupled to the camera. The user device may include a server or other computer. The camera may be a portion of a computer that includes the controller, for example.

In various implementations, a computer may include one or more processors that executes instructions and manipulates data to perform operations of the controller and a memory. The processor may include a programmable logic device, a microprocessor, or any other appropriate device for manipulating information in a logical manner. A memory may include any appropriate memory including a variety of repositories, such as, SQL databases, relational databases, object oriented databases, distributed databases, XML databases, and/or web server repositories. Furthermore, memory may include one or more forms of memory such as volatile memory (e.g., RAM) or nonvolatile memory, such as read-only memory (ROM), optical memory (e.g., CD, DVD, or LD), magnetic memory (e.g., hard disk drives, floppy disk drives), NAND flash memory, NOR flash memory, electrically-erasable, programmable read-only memory (EEPROM), Ferroelectric random-access memory (FeRAM), magnetoresistive random-access memory (MRAM), non-volatile random-access memory (NVRAM), non-volatile static random-access memory (nvSRAM), and/or phase-change memory (PRAM).

In various implementations, the memory may include data, such as common latent time, latent time associated with specific instructions and/or numbers of instructions, user information, etc. In addition, various software may be stored on the memory. For example, instructions (e.g., operating systems, camera control software, and/or other types of software) and one or more LIA operating modules (e.g., instructions to perform operations when executed by a processor of the system) may be stored on the memory of the computer (e.g., user device, controller). The LIA operation module may perform various described processes. For example, the LIA operation module may receive inputs and/or convert inputs from users into instructions for the camera. The LIA operation module may generate one or more GUIs based on the described processes (e.g., cross hairs, quadrant views, etc.)

A graphical User interface (GUI) generated by the system may be displayed on a presentation interface of the User device, such as a monitor or screen. GUI may be operable to allow the User of a User device to interact with repositories and/or various interface(s). Generally, GUI provides a User with an efficient and User-friendly presentation of data provided by the system. GUI includes a plurality of displays having interactive fields, such as images, icons, overlays, pull-down lists, fillable fields, and editable text operated by the User. And in one example, GUI presents an explore-type interface and receives commands from the User. It should be understood that the term Graphical User interface may be used in the singular or in the plural to describe one or more Graphical User Interfaces in each of the displays of a particular graphical User interface. Further, GUI contemplates any graphical user interface, such as a generic web browser, that processes information in the system and/or User device and efficiently presents the information to the User. In some implementations, GUI may present a web page embedding content. The server can accept data from a User device(s) via the web browser (e.g., Microsoft Internet Explorer or Netscape Navigator) and return the appropriate Hyper Text Markup Language (HTML) or eXtensible Markup Language (XML) responses.

A communication interface may allow the computer to communicate with components (e.g., controller and/or camera) and/or other computer systems. The communication interface may transmit data from the computer and/or receive data from other components, other repositories, and/or other computer systems via network protocols (e.g., TCP/IP, Bluetooth, and/or Wi-Fi) and/or a bus (e.g., serial, parallel, USB, and/or FireWire).

The computer may include a presentation interface to present data to a user, such as though a monitor and speakers. The presentation interface may facilitate receipt of input for operation from users and/or present various GUIs to the user.

The computer may include a server, as well as a server pool. For example, the computer may include a general-purpose personal computer (PC) a Macintosh, a workstation, a UNIX-based computer, a server computer, or any other suitable device. According to one implementation, a computer may include a web server. The computer may be adapted to execute any operating system including UNIX, Linux, Windows, or any other suitable operating system. The computer may include software and/or hardware in any combination suitable to provide access to data and/or translate data to an appropriate compatible format.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable signal(s) may be non-transitory waves and/or non-transitory signals.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackpad) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “an instruction” includes a combination of two or more instructions and reference to “a camera” includes different types and/or combinations of cameras. Reference to “LIA” may include a combination of two or more processes or portions thereof.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method comprising:
receiving one or more images from a camera;
receiving one or more instructions regarding the camera;
determining a latency period, wherein the latency period is based on an elapsed time between a time when an instruction is received and a time when the camera performs an operation based on the received instruction; and
generating a graphical user interface using a processor based on the latency period for presentation to a user.

2. The method of claim 1, wherein at least one of the instructions regarding the camera comprises an instruction regarding an orientation of the camera.

3. The method of claim 1, wherein determining the latency period is at least partially based on at least one of a camera controller system time, time stamp, time to allow video encoding, or time to allow video decoding.

4. The method of claim 1,
wherein the graphical user interface comprises at least one image received from the camera and an overlay;
wherein the overlay comprises one or more overlay parts presented on top of a presented image; and
wherein generating the graphical user interface based on the latency period comprises displaying the latency period on the overlay.

5. The method of claim 1, further comprising:
generating one or more additional instructions regarding the camera based on the determined latency period.

6. The method of claim 1, further comprising:
presenting one or more instructions regarding the camera on the graphical user interface.

7. The method of claim 6, further comprising:
restricting presentation of one or more of the instructions when the camera has allowed at least one response based on one or more of the instructions.

8. The method of claim 1,
wherein the graphical user interface comprises at least one image received from the camera and an overlay;
wherein the overlay comprises one or more overlay parts presented on top of a presented image;
wherein at least one of the overlay parts comprises a virtual cross-hair; and
wherein generating a user interface based on the latency period comprises presenting the virtual cross-hair based on the received instructions regarding the camera.

9. A method comprising:
detecting a moving object in a field of view of a camera;
determining whether the moving object is maintained in the field of view of the camera; and
determining one or more potential positions of the camera based at least partially on a Kalman filter algorithm, if a determination is made that the moving object has not been maintained in the field of view of the camera.

10. The method of claim 9, further comprising:
determining a latency period, wherein the latency period is based on an elapsed time between a time when at least one instruction is received for the camera and a time when the camera performs an operation based on one or more of the received instructions; and
wherein determining a potential position of the camera is based at least partially on the determined latency period.

11. The method of claim 9, further comprising:
automatically determining an instruction for the camera based on a determined potential position of the camera such that the moving object is in the field of view of the camera when the camera is in the determined potential position.

12. The method of claim 9, further comprising:
determining an instruction for the camera based on a determined potential position; and
transmitting the determined instruction for the camera.

13. The method of claim 9,
wherein determining one or more potential positions of the camera is based at least partially on at least one of a determined trajectory of the moving object or a determined speed of the moving object; and further comprising:
generating a graphical user interface using a processor for presentation to the user;
wherein the graphical user interface comprises at least one image received from the camera and an overlay;
wherein the overlay comprises one or more overlay parts presented on top of a presented image;
wherein at least one of the overlay parts comprises a density overlay; and
wherein the density overlay is based at least partially on a probability that the moving object is in an area on the presented image.

14. The method of claim 9, further comprising:
determining one or more potential deviations from a trajectory of the moving object based on identified paths in an image captured by the camera.

15. A method comprising:
identifying an object in a field of view of a camera;
determining whether the identified object is maintained in the field of view of the camera; and
determining one or more potential camera positions, if a determination is made that the identified object is not maintained in the field of view of the camera.

16. The method of claim 15:
wherein determining one or more potential positions of the camera is based at least partially on at least one of a determined trajectory of the moving object, a determined speed of the moving object, or a Kalman filter algorithm; and further comprising:
generating a graphical user interface using a processor for presentation to the user;
wherein the graphical user interface comprises at least one image received from the camera and an overlay;
wherein the overlay comprises one or more overlay parts presented on top of a presented image;
wherein at least one of the overlay parts comprises a density overlay; and
wherein the density overlay is based at least partially on a probability that the moving object is in an area on the presented image.

17. The method of claim 15, further comprising:
generating a graphical user interface using a processor based on a determined latency period;
wherein the graphical user interface comprises at least one image received from the camera and an overlay;
wherein the overlay comprises one or more overlay parts presented on top of a presented image;
wherein at least one of the overlay parts comprises a virtual cross-hair; and
wherein the graphical user interface comprises presenting the virtual cross-hair based on instructions received regarding the camera.

18. The method of claim 15, further comprising:
generating a digital footprint of the identified object while tracking the object; and
generating a graphical user interface using a processor when a determination is made that the identified object is not maintained in the field of view of the camera;
wherein the graphical user interface comprises at least one image received from the camera and an overlay;
wherein the overlay comprises one or more objects presented on top of a presented image; and
wherein the overlay comprises one or more indicia corresponding to portions of the presented image that at least approximately match the generated digital footprint.

19. The method of claim 15,
wherein the identified object comprises a moving object;
wherein determining one or more potential positions of the camera is based at least partially on at least one of a determined trajectory of the moving object or a determined speed of the moving object; and further comprising:
generating a graphical user interface using a processor for presentation to the user;
wherein the graphical user interface comprises at least one image received from the camera and an overlay;
wherein the overlay comprises one or more overlay parts presented on top of a presented image;
wherein at least one of the overlay parts comprises a density overlay; and
wherein the density overlay is based at least partially on a probability that the moving object is in an area on the presented image.

20. The method of claim 15, further comprising:
determining a latency period, wherein the latency period is based on an elapsed time between a time when at least one instruction is received for the camera and a time when the camera performs an operation based on the received instruction; and
wherein determining one or more potential positions of the camera is based at least partially on the determined latency period.
